(19) United States
(12) Patent Application Publication
(10) Pub. No.: US 2011/0147283 A1
(43) Pub. Date: Jun. 23, 2011

(54) WATER TREATMENT FOR COOLING TOWERS AND LARGE COMMERCIAL PONDS USING A NON-CHEMICAL RESIDUAL PROGRAM

(76) Inventors: John Victor Taylor, Auburn, CA (US); Clayton Ashley Helvey, San Dimas, CA (US)

(21) Appl. No.: 12/955,330

(22) Filed: Nov. 29, 2010

Related U.S. Application Data
(60) Provisional application No. 61/287,345, filed on Dec. 17, 2009.

(51) Int. Cl. C02F 9/02; C02F 1/02; C02F 1/32; C02F 1/78

(52) U.S. Cl. 210/95; 210/177; 210/138; 210/96.1; 210/85

(57) ABSTRACT

A water treatment system can be used to treat bodies of water as found in cooling towers and large commercial ponds to rid the potential of biological contaminants and mineral formations found in heat exchange equipment, on the sides of walls, basins and piping that create corrosive damage and loss of energy through deposits on heat transfer surfaces. The water treatment system may include a recirculating pump for moving water through the system, a filtration system for filtering solids, an ozonator and a UV light for creating an advanced oxidation process, permanent magnets for electrodynamically aligning dissolved minerals in the water, and a heating element for thermodynamically controlling calcium carbonate scaling potential.

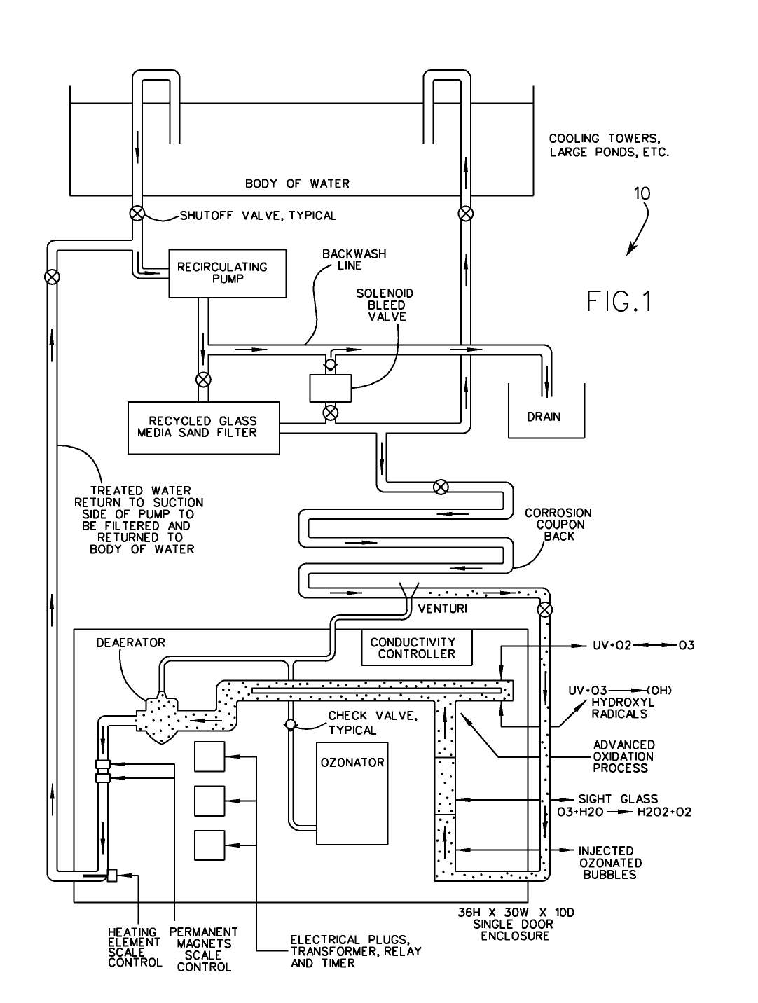

### CROSS-REFERENCE TO RELATED APPLICATIONS

This application claims the benefit of priority to U.S. Provisional patent application number 61/287,345, filed Dec. 17, 2009, which is herein incorporated by reference.

### BACKGROUND OF THE INVENTION

The present invention relates to water treatment apparatus and, more particularly, to water treatment apparatus for inhibiting scale, corrosion and biological formation in cooling towers and large commercial ponds by using a non-chemical residual program.

In bodies of water, such as cooling towers and large commercial ponds, biological growth, corrosion and scale deposits cause an unhealthful environment, premature loss of the system's metal components and energy loss due to scale deposits on the heat transfer surfaces. The current chemical systems work for water treatment, but they are expensive, toxic and unsustainable, as every bit of these systems are flushed down the sanitary sewer drain once used.

As can be seen, there is a need for a water treatment system for cooling towers and large commercial ponds using a non-chemical residual program.

### SUMMARY OF THE INVENTION

In one aspect of the present invention, a water treatment system comprises a pump for recirculating water to and from a body of water; a filtration system for removing suspended solids from water before entering into the treatment center of the water treatment system; a venturi for feeding ozone, oxygen and nitrogen into a flow of water from the body of water; a ultraviolet (UV) lamp for delivering UV energy into the flow of water, the UV energy capable of forming hydroxyl radicals from the ozone and water; magnets placed about a pipe carrying the flow of water, the magnets adapted to produce an electrostatic field to align at least a portion of dissolved minerals in the flow of water; and a heating element for warming the flow of water.

These and other features, aspects and advantages of the present invention will become better understood with reference to the following drawings, description and claims.

### BRIEF DESCRIPTION OF THE DRAWINGS

The FIGURE is a schematic drawing of a water treatment system according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a water treatment system that can be used to treat bodies of water as found in cooling towers and large commercial ponds to rid the potential of biological contaminants and mineral formations found in heat exchange equipment, on the sides of walls, basins and piping that create corrosive damage and loss of energy through deposits on heat transfer surfaces. The water treatment system may include a recirculating pump for moving water through the system, a filtration system for filtering solids, an ozonator and a UV light for creating an advanced oxidation process, permanent magnets for electrodynamically aligning dissolved minerals in the water, and a heating element for thermodynamically controlling calcium carbonate scaling potential.

In summarizing the FIGURE, the recirculating pump may be used to receive water from the source (body of water, such as a cooling tower, a large pond, or the like) and send the water to be filtered. Filtration may be used to maintain clean water through the coupon rack, probe, venturi and treatment center in order to effectively maintain consistent results. The corrosion coupons may monitor the corrosion rates of most of the metals in the system. A conductivity controller may monitor conductivity levels of dissolved minerals in the water via a conductivity probe and open a solenoid bleed valve to drain all excess levels of the dissolved minerals. The ozonator and venturi may create ozonated bubbles in the water and, when in contact with UV light, may form hydroxyl radicals, which may kill and/or deactivate nearly all biological contaminates and oxidize most dissolved minerals found in the body of water. The de-aerator helps remove some of the gases and recycles them back through to enhance the treatment of the water. The electrostatic field (permanent magnets) and heating element help reduce the scaling potential by coagulation and precipitation while allowing water savings.

Referring to the FIGURE in greater detail, the filtration may remove sediment from the body of water. The filtration may be accomplished with a recycled glass media sand filter. Filtration in sizes ranging from 19″ to 24″ to 36″ may be used to remove suspended solids from the body of water before entering the treatment center and then used again following treatment to remove suspended and large colloidal particles before re-entering the main body of water. The filtration system may include an automatic backwash system with the appropriate valves to open and close at predetermined times.

Following filtration, a portion of the water may be redirected into a corrosion coupon rack at a predetermined rate of flow, typically between about 3 to about 10 gallons per minute. This flow may activate the venturi to pull ozone and recycled gas into the water stream. The ozone may be delivered from a corona discharge ozonator through a compressor or pump and the venturi. The water may continue at the flow rate past a conductivity probe (not shown) that signals the dissolved mineral level to the conductivity controller, which may open a solenoid bleed valve to remove excess dissolved minerals. Once satisfied, the conductivity controller may close the solenoid bleed valve to save water.

The water then enters the treatment center and a vertical glass tube may be provided, such as a 2-inch diameter tube, where ozonated bubbles may be observed. The ozonated bubbles in water naturally yield hydrogen peroxide. The hydrogen peroxide, ozone, oxygen, nitrogen and water are then exposed to a predetermined frequency UV light (often between about 240 nanometers and about 280 nanometers) in a typically 2-inch diameter horizontal chamber, where the ozone is decomposed to create hydroxyl radicals. The hydroxyl radicals may kill and/or deactivate nearly all biological contaminates, oxidize most dissolved minerals that pass through and may increase the water's pH level to inhibit corrosion rates. The hydroxyl radical is short lived, but may provide an array of benefits in inhibiting scale, corrosion and biological deposits from forming in a heat exchanger.

The water may then pass through a de-aerator that may recycle some of the gases back into the venturi to help create more hydroxyl radicals. The water may then enter a third 2-inch diameter vertical chamber where permanent magnets may create an alignment of some of the dissolved hardness minerals into a non-adhering amorphous sludge, which may inhibit harden calcium carbonate scaling potential on heat transfer surfaces and the like. The water flow may then enter a fourth 2-inch horizontal chamber, where it may be exposed to a heating element, creating higher water temperatures (for example, between about 90 and about 120 degrees F.) to encourage the precipitation of calcium carbonate scaling potential even further.

The water may exit the treatment center and may be re-filtered to remove suspended and large colloidal particles prior to mixing it with the main body of water.

An electrical pack may be provided in the treatment center as a source of power for the ozonator, UV lamp, actuators for automatic filter backwash, the heating element and the conductivity controller.

The treatment center may be enclosed. For example, a 36-inch by 30-inch by 10-inch sloped enclosure may be used. The entire treatment assembly may be mounted on a 48-inch by 40-inch or larger portable skid.

It should be understood, of course, that the foregoing relates to exemplary embodiments of the invention and that modifications may be made without departing from the spirit and scope of the invention as set forth in the following claims.

What is claimed is:

1. A water treatment system comprising:
a pump for recirculating water to and from a body of water;
a filtration system for removing suspended solids from water before entering a treatment center of the water treatment system and refiltering to remove suspended and large colloidal particles created by the treatment center;
a venturi for feeding ozone, oxygen and nitrogen into a flow of water from the body of water;
a ultraviolet (UV) lamp for delivering UV energy into the flow of water, the UV energy capable of forming hydroxyl radicals from the ozone and water;
a magnets placed about a pipe carrying the flow of water, the magnets adapted to produce an electrostatic field to align at least a portion of dissolved minerals in the flow of water; and
a heating element for warming the flow of water.

2. The water treatment system of claim 1, wherein the filtration system includes a recycled glass media sand filter.

3. The water treatment system of claim 1, further comprising an automatic backwash system for cleaning the filtration system at predetermined intervals.

4. The water treatment system of claim 1, further comprising a corrosion coupon rack adapted to monitor corrosion rates in the flow of water.

5. The water treatment system of claim 1, further comprising a conductivity controller for measuring the conductivity in the flow of water and, as needed, opening a solenoid bleed valve to adjust the conductivity in the flow of water accordingly.

6. The water treatment system of claim 1, wherein the magnets are permanent magnets.

7. The water treatment system of claim 1, wherein the heating element warms the flow of water to a temperature between about 90 and about 120 degrees F.

8. The water treatment system of claim 1, further comprising a sight glass for monitoring the ozone in the flow of water.

9. The water treatment system of claim 1, further comprising an ozonator for providing ozone to the venturi.

10. The water treatment system of claim 1, further comprising a de-aerator adapted to recycle gases back to the venturi.
